(19) United States
(12) Patent Application Publication
(10) Pub. No.: US 2011/0074430 A1
(43) Pub. Date: Mar. 31, 2011

(54) METHOD FOR EVALUATING SECONDARY BATTERY

(75) Inventors: Sho Tsuruta, Kobe-city (JP); Katsunori Yanagida, Kobe-city (JP)

(73) Assignee: SANYO ELECTRIC CO., LTD., Osaka (JP)

(21) Appl. No.: 12/893,534

(22) Filed: Sep. 29, 2010

(30) Foreign Application Priority Data
Sep. 29, 2009 (JP) 2009-223861

(51) Int. Cl. G01N 27/416

(52) U.S. Cl. 324/426

(57) ABSTRACT

A method for evaluating a secondary battery includes repeatedly performing: an open circuit voltage measurement step of measuring the open circuit voltage of the secondary battery to be evaluated at each of a plurality of temperatures; a potential change measurement step of measuring, after the open circuit voltage measurement step, the potential change in the secondary battery while changing the state of charge of the secondary battery; and an equilibrium potential measurement step of measuring the equilibrium potential of the secondary battery after the potential change measurement step. An entropy variation in each of the different states of charge is calculated based on the open circuit voltages at the plurality of temperatures measured in the state of charge, and a chemical diffusion coefficient in each of the different states of charge is calculated based on the equilibrium potential of the secondary battery and the potential change in the secondary battery both measured in the state of charge. The secondary battery is evaluated based on the entropy variations and the chemical diffusion coefficients in the different states of charge.

### BACKGROUND OF THE INVENTION

1. Field of the Invention

This invention relates to a method for evaluating a secondary battery.

2. Description of Related Arts

With the recent rapid spread of mobile information equipment and the like, considerable research and development has been conducted on them. In addition, the cycle of research and development of mobile information equipment and the like has been rapidly shortened. Along with this, also on secondary batteries essential for mobile information equipment and the like, research and development has been conducted in a very short cycle.

In the research and development of secondary batteries, it is important to exactly and accurately evaluate properties of secondary batteries, such as for example the state of an active material and the cycle life. However, it is difficult to directly detect properties of secondary batteries, for example, using microscopes or X-ray analysis. Therefore, research has been actively conducted on evaluation methods capable of exactly and accurately evaluating a secondary battery. At present, some useful evaluation methods are proposed.

For example, Published Japanese Patent Application No. 2009-506483 proposes the following evaluation method. Entropy variations (ΔS) of a secondary battery in different states of charge are calculated, wherein each entropy variation (ΔS) is calculated from results of measured open circuit voltages (OCVs) of the secondary battery at different temperatures in a certain state of charge. Then, a graph is drawn up by plotting entropy variation (ΔS) against state of charge. This document describes a method for evaluating the energy, power density, amount of current and cycle life of the secondary battery from the obtained graph (hereinafter, the evaluation method described in Published Japanese Patent Application No. 2009-506483 is referred to as a “thermodynamic evaluation method”).

Alternatively, in Weppner and R. A. Huggins, “Determination of the Kinetic Parameters of Mixed-Conducting Electrodes and Application to the System Li3Sb,” J. Electrochem. Soc., 124, 1569 (1977), the following evaluation method is proposed. Chemical diffusion coefficients of a secondary battery in different states of charge are calculated, wherein each chemical diffusion coefficient is calculated from the potential change of the secondary battery during application of current thereto in a certain state of charge. Then, a graph is drawn up by plotting chemical diffusion coefficient against state of charge. This document describes a method for evaluating kinetic parameters of electrodes from the obtained graph (hereinafter, the evaluation method described in this document is referred to as an “electrochemical evaluation method”).

### SUMMARY OF THE INVENTION

The thermodynamic evaluation method described in Published Japanese Patent Application No. 2009-506483 and the electrochemical evaluation method described in Weppner and R. A. Huggins, “Determination of the Kinetic Parameters of Mixed-Conducting Electrodes and Application to the System Li3Sb,” J. Electrochem. Soc., 124, 1569 (1977) are both very useful as evaluation methods for a secondary battery. In addition, in order to more accurately evaluate a secondary battery, both the thermodynamic evaluation method and the electrochemical evaluation method are preferably used. Therefore, previously, secondary batteries have been subjected to a comprehensive evaluation by first being subjected to one of the thermodynamic and electrochemical evaluation methods and then subjected to the other.

However, the inventors' intensive studies have revealed that if one of the thermodynamic and electrochemical evaluation methods is first performed and the other is then performed, the second evaluation performed does not provide accurate evaluation results.

The present invention has been made in view of the foregoing points, and an object thereof is therefore to provide a method for evaluating a secondary battery whereby both of the thermodynamic and electrochemical evaluations can be accurately performed for a single secondary battery.

The inventors have found through their intensive studies that the reason why, out of the thermodynamic and electrochemical evaluation methods, the second evaluation method performed does not provide accurate evaluation results is that the nature of the secondary battery has been changed in the course of execution of the first evaluation method. Specifically, each of the thermodynamic evaluation method and the electrochemical evaluation method must be performed in a plurality of states of charge. Therefore, when a measurement in a certain state of charge is completed, it is necessary to change the state of charge such as by passing the current through the battery and then make a subsequent measurement. This involves repeated charging in a plurality of times during execution of a single evaluation method. As a result, the nature of the secondary battery may slightly change. Thus, a problem arises in that the second evaluation method performed does not provide accurate evaluation results. Based on this finding, the inventors have completed the present invention.

Specifically, a method for evaluating a secondary battery according to the present invention includes repeatedly performing an open circuit voltage measurement step, a potential change measurement step and an equilibrium potential measurement step. The open circuit voltage measurement step is the step of measuring the open circuit voltage of a secondary battery to be evaluated at each of a plurality of temperatures. The potential change measurement step is the step of measuring, after the open circuit voltage measurement step, the potential change in the secondary battery while changing the state of charge of the secondary battery. The equilibrium potential measurement step is the step of measuring the equilibrium potential of the secondary battery after the potential change measurement step. In the method for evaluating a secondary battery according to the present invention, an entropy variation in each of the different states of charge is calculated based on the open circuit voltages at the plurality of temperatures measured in the state of charge. A chemical diffusion coefficient in each of the different states of charge is calculated based on the equilibrium potential of the secondary battery and the potential change in the secondary battery both measured in the state of charge. The secondary battery is evaluated based on the entropy variations and the chemical diffusion coefficients in the different states of charge.

In the present invention, the measurement of open circuit voltages for performing a thermodynamic evaluation and the measurement of a potential change and an equilibrium potential for performing an electrochemical evaluation are alternately made. Thus, the thermodynamic evaluation and the electrochemical evaluation can be concurrently performed. Therefore, unlike, for example, the sequential execution of the thermodynamic evaluation and the electrochemical evaluation, it can be effectively prevented that the nature of the secondary battery changes prior to the execution of the thermodynamic evaluation or the electrochemical evaluation. Hence, according to the present invention, both of the thermodynamic evaluation and electrochemical evaluation can be accurately performed for a single battery.

Particularly, for example, even in the case where the positive-electrode active material is denatured owing to a change in state of charge, both of the thermodynamic evaluation and electrochemical evaluation can be accurately performed for the single battery.

Previously, when a certain parameter is measured in a plurality of states of charge, the period of time for changing the state of charge is generally minimized, such as in order to shorten the measurement time. In other words, charging is generally made at the highest possible rate. Unlike this, in the present invention, changing the state of charge is performed in the potential change measurement step. In the potential change measurement step, the state of charge is changed, not abruptly, but gradually. Therefore, in the present invention, the change in nature of the secondary battery during changing of the state of charge can be reduced. Hence, according to the present invention, both of the thermodynamic evaluation and electrochemical evaluation can be accurately performed for a single battery.

As described above, in the present invention, changing the state of charge is performed in the potential change measurement step. Therefore, as compared to the case where changing the state of charge must be additionally performed besides in the potential change measurement step, such as the case of sequential execution of the thermodynamic evaluation and the electrochemical evaluation, measurement can be promptly and easily made.

In the present invention, the open circuit voltage measurement step is preferably performed while the state of charge after the completion of the equilibrium potential measurement step is kept. In other words, it is preferable that after the completion of the equilibrium potential measurement step, the state of charge not be changed before the start of the open circuit voltage measurement step. Thus, changing of the state of charge that may cause a change in nature of the secondary battery can be minimized. Hence, both of the thermodynamic evaluation and electrochemical evaluation can be further accurately performed.

In the present invention, the method for calculating the entropy variation is not particularly limited. The entropy variation can be calculated, for example, by the method described in Published Japanese Patent Application No. 2009-506483. Specifically, for example, the entropy variation can be calculated by multiplying the ratio (δ(ΔE)/δT) of the variation (ΔE) in open circuit voltage to the variation (δT) in temperature by the Faraday constant (F), wherein the ratio (δ(ΔE)/δT) is determined from results of the measured open circuit voltages at the plurality of temperatures.

In the present invention, the method for calculating the chemical diffusion coefficient is not particularly limited. The chemical diffusion coefficient can be calculated, for example, by the galvanostatic intermittent titration technique (GITT) described in the above-mentioned document, Weppner and R. A. Huggins, “Determination of the Kinetic Parameters of Mixed-Conducting Electrodes and Application to the System Li3Sb,” J. Electrochem. Soc., 124, 1569 (1977). Specifically, for example, the chemical diffusion coefficient (D) can be calculated according to the following formula (1). Note that in the calculation according to the formula (1), the inequality t<<L²/D must be satisfied. The inequality “t<<L²/D” means that t is sufficiently smaller than L²/D, and t is preferably not more than one hundredth of L²/D.

D=(4π)(V_{M}/SFzᵢ)²[{I₀(dE/dδ)}/(dEₜ/dt^{1/2})]² (1)

where:

D represents the chemical diffusion coefficient;

V_{M} represents the volume per mole of an active material (unit: cm³/mol);

S represents the area of the interface between an electrode and an electrolyte (unit: cm²);

F represents the Faraday constant;

zᵢ represents the electrical conductivity due to the charge number;

I₀ represents the applied current (unit: A);

E represents the open circuit voltage (unit: V);

dδ represents the deviation of chemical species contributing to the electrochemical reaction (unit: moles);

Eₜ represents the potential during charging or discharging;

t represents the charging time in a potential change measurement step (unit: seconds); and

L represents the thickness of the electrode of the secondary battery (unit: cm).

The method for evaluating a secondary battery according to the present invention can be applied to every kind of secondary battery. The method for evaluating a secondary battery of the present invention is particularly useful for, among others, evaluation of lithium secondary batteries. The reason for this is that the entropy variation is responsive to changes of the electrode material of a lithium secondary battery, the reaction in many lithium secondary batteries is limited by diffusion of lithium ions and a combination of changes in entropy variation and changes in chemical diffusion coefficient can therefore be usefully used for diagnosis of battery conditions, such as understanding of a degraded state.

Note that in the present invention, the term secondary battery includes not only those having a metal outer package but also test cells for evaluation, such as glass cells, and laminate cells.

### BRIEF DESCRIPTION OF DRAWINGS

FIG. 1 is a graph showing results of measured open circuit voltages in Example 1.

FIG. 2 is a graph in which respective open circuit voltages at different temperatures in Example 1 are plotted.

FIG. 3 is a graph showing results of measured potential change in Example 1.

FIG. 4 is a time chart for entropy variation determination and chemical diffusion coefficient determination in Example 1.

FIG. 5 shows graphs representing entropy variation and chemical diffusion coefficient against amount of lithium in a positive-electrode active material in Example 1.

FIG. 6 shows X-ray diffraction patterns of lithium cobaltate with various amounts of lithium.

FIG. 7 shows graphs representing entropy variation and chemical diffusion coefficient against amount of lithium in a positive-electrode active material in Example 2.

FIG. 8 shows X-ray diffraction patterns of LiNi_{1/3}Co_{1/3}Mn_{1/3}O₂ with various amounts of lithium.

FIG. 9 shows a graph representing entropy variation against amount of lithium in a positive-electrode active material in Comparative Example.

FIG. 10 shows a graph representing chemical diffusion coefficient against amount of lithium in the positive-electrode active material in Comparative Example.

### DETAILED DESCRIPTION

Hereinafter, the present invention will be described in more detail with reference to specific examples. However, the present invention is not limited at all by the following examples, and can be embodied in various other forms appropriately modified without changing the spirit of the invention.

### Example 1

### Production of Test Cell

Mixed together were 95 parts by weight of lithium cobaltate serving as a positive-electrode active material, 2.5 parts by weight of carbon serving as an electronic conductor and 2.5 parts by weight of poly(vinylidene fluoride) serving as a binder. Thereafter, N-methyl-2-pyrrolidone was added to the resultant mixture, thereby preparing a slurry for forming a positive electrode mixture layer. The slurry was applied to one side of a current collector made of an aluminum foil, dried, rolled and then cut into a plate with 5.7 cm×2.5 cm. Finally, a positive electrode tab was attached to the plate, thereby producing a positive electrode (working electrode).

A counter electrode and a reference electrode were each composed of a lithium metal plate.

A nonaqueous electrolyte was used in which lithium hexafluorophosphate was dissolved as an electrolyte salt in a nonaqueous solvent made of a mixture of ethylene carbonate and ethyl methyl carbonate mixed in a volume ratio of 3:7 to reach a concentration of 1 mol/L.

A polyethylene microporous film was used as a separator.

Next, a test cell was produced using the working electrode, the counter electrode, the reference electrode, the separator and the nonaqueous electrolyte.

<Preparatory Measurement>

The produced test cell was first charged at a constant current with a current density of 15 mA/g until the potential of the working electrode reached 5 V with respect to the reference electrode. Then, the charge capacity Q1 per unit weight of the working electrode was calculated. Based on the charge capacity Q1, the current density for the subsequent measurements was calculated.

<Evaluation of Test Cell>

Entropy Variation Determination

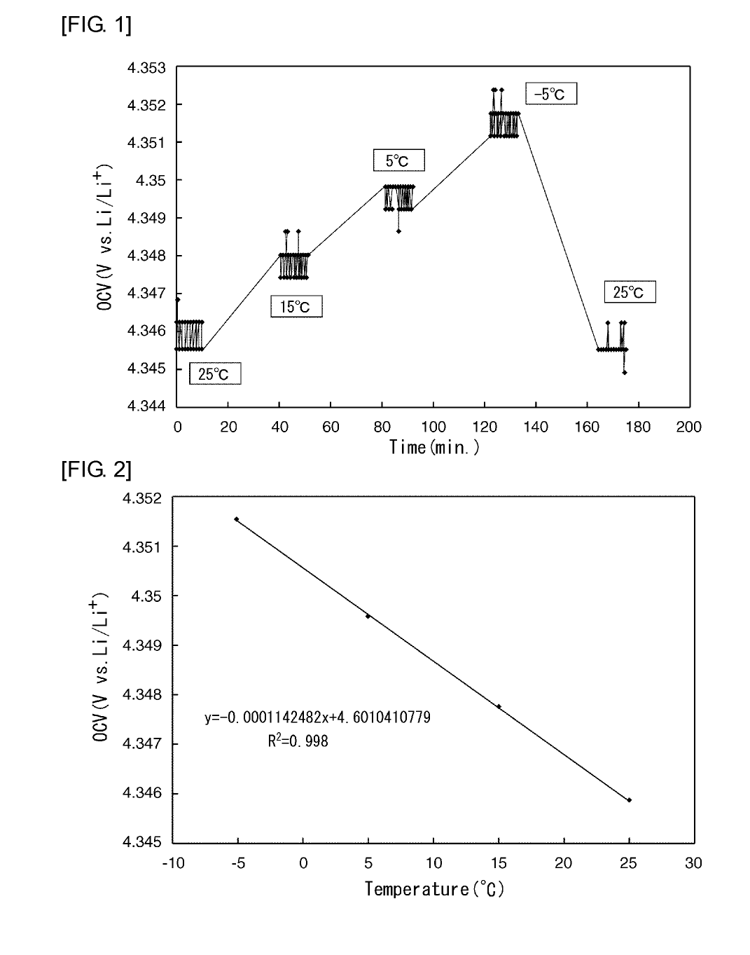

First, the open circuit voltage of the test cell was measured for 10 minutes at each temperature of 25° C., 15° C., 5° C. and −5° C. The measured results are shown in FIG. 1. Next, the average value of voltages at each temperature was defined as the open circuit voltage (OCV) at that temperature. Next, the OCVs at the different temperatures were plotted on a graph by laying off temperatures as abscissas and OCVs as ordinates, and an approximate curve of OCV vs. temperature was determined. The graph is shown is FIG. 2. In the graph of FIG. 2, the gradient of the approximate curve corresponds to the entropy variation (AS). Therefore, from the approximate curve, an entropy variation was calculated.

Chemical Diffusion Coefficient Determination (Measurement of Potential Change and Equilibrium Potential)

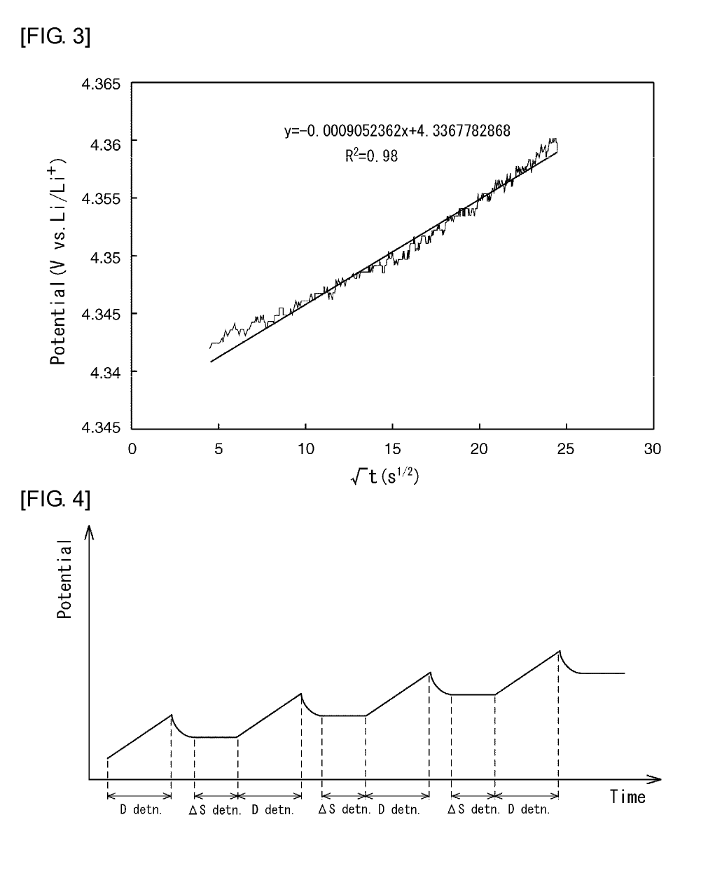

Under the condition that the current density required to charge up the charge capacity Q1 in an hour was defined as 1 It, the potential change of the test cell was measured at 25° C. while the current was passed through the test cell with a current density of 1/20 It for 10 minutes. The measured results were plotted on a graph by laying off one-half powers (t^{1/2}) of the time t as abscissas and potentials as ordinates, and an approximate curve of potential vs. time was determined. The graph is shown is FIG. 3. In the graph of FIG. 3, the gradient of the approximate curve can be represented as dEₜ/d(t^{1/2}).

Next, after the completion of the passage of current, the test cell was allowed to stand for 120 minutes. Thereafter, the potential of the working electrode was measured with respect to the reference electrode, and the measured potential was defined as an equilibrium potential.

Then, from the gradient (dEₜ/dt^{1/2}) of the approximate curve of FIG. 3 and the equilibrium potential, a chemical diffusion coefficient was determined according to the following formula (I).

D=(4/π)(V_{M}/SFzᵢ)²[{I₀(dE/dδ)}/(dEₜ/dt^{1/2})]² (1)

where:

D represents the chemical diffusion coefficient;

V_{M} represents the volume per mole of an active material (unit: cm³/mol);

S represents the area of the interface between an electrode and an electrolyte (unit: cm²);

F represents the Faraday constant;

zᵢ represents the electrical conductivity due to the charge number (zᵢ=1);

I₀ represents the applied current (unit: A);

E represents the OCV (unit: V);

dδ represents the deviation of chemical species (lithium) contributing to the electrochemical reaction (unit: moles);

Eₜ represents the potential during charging or discharging;

t represents the charging time in the potential change measurement step (unit: seconds); and

L represents the thickness of the electrode of the test cell (unit: cm).

In the formula, V_{M} was calculated using the powder density (2.68 g/cm³) of lithium cobaltate, and S was calculated by multiplying the specific surface area (0.35 m²/g) of lithium cobaltate calculated by the BET method by the weight of the active material.

Repeated Determination

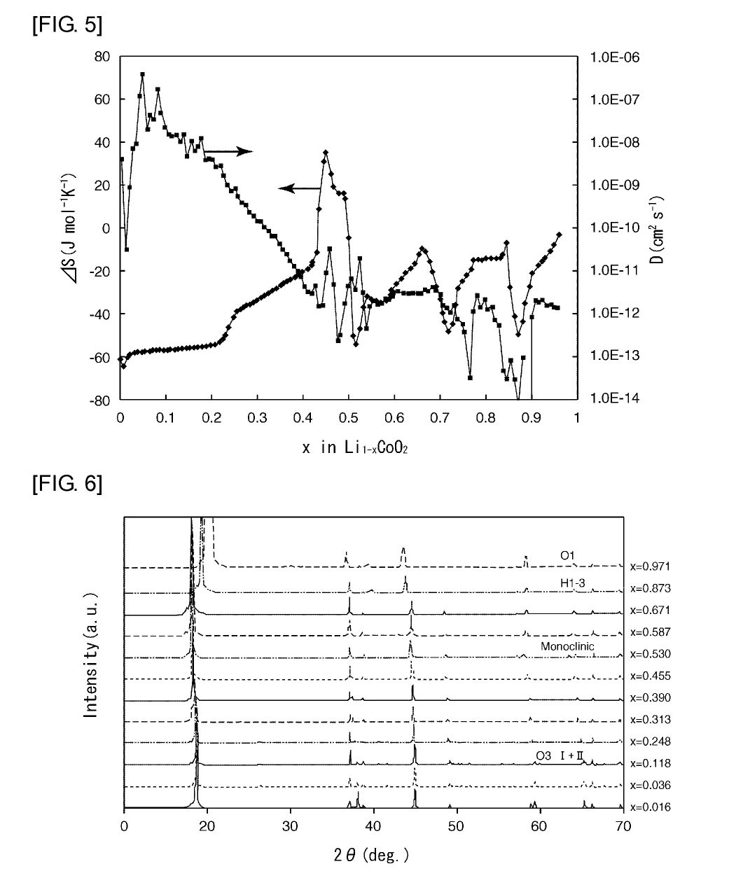

The entropy variation determination (ΔS determination) and the chemical diffusion coefficient determination (D determination) were repeated according to the time chart shown in FIG. 4. Thus, entropy variations and chemical diffusion coefficients in different states of charge were determined. The results are shown in FIG. 5. Note that FIG. 5 indicates amount of lithium in the positive-electrode active material as a parameter corresponding to state of charge.

Evaluation of Test Cell

The test cell was evaluated based on the entropy variations and chemical diffusion coefficients shown in FIG. 5.

Referring to the results shown in FIG. 5, the graph representing entropy variations showed a plateau region until the amount of lithium eliminated reached approximately 0.2. When the amount of lithium eliminated exceeded approximately 0.2, the entropy variation increased with increasing amount of lithium eliminated. Then, when the amount of lithium eliminated reached near 0.4, the entropy variation abruptly increased and reached a positive value. Thereafter, when the amount of lithium eliminated reached approximately 0.5, the entropy variation abruptly decreased and reached a negative value again. In a zone where the amount of lithium eliminated was greater, the entropy variation repeatedly increased and decreased with increasing amount of lithium eliminated. According to the X-ray diffraction patterns shown in FIG. 6, it can be seen that lithium cobaltate used as an active material for the working electrode changed the phase, with the progress of charging, from the O3 structure to the two-phase coexistence structure of O3 and O3II, then to the O3II structure, then to the monoclinic structure, then to the O3 structure, then to the H1-3 structure and then to the O1 structure. These results show that the changes in entropy variation correspond to the phase transitions.

On the other hand, referring again to FIG. 5, the chemical diffusion coefficient decreased with increasing amount of lithium eliminated until the amount of lithium eliminated reached approximately 0.4. Thereafter, when the amount of lithium eliminated reached near 0.5, the chemical diffusion coefficient repeatedly increased and decreased with increasing amount of lithium eliminated. These results show that, like the results of determined entropy variations, the changes in chemical diffusion coefficient correspond to the phase transitions shown in FIG. 6.

As seen from the above, according to this example, the structural changes of the positive-electrode active material with changes in state of charge could be detected without damage to the test cell.

### Example 2

A test cell was produced and evaluated in the same manner as in Example 1 except that LiNi_{1/3}Co_{1/3}Mn_{1/3}O₂ was used as a positive-electrode active material.

In this case, the powder density of LiNi_{1/3}Co_{1/3}Mn_{1/3}O₂ was 2.42 g/cm³, and the specific surface area thereof calculated by the BET method was 0.31 m²/g.

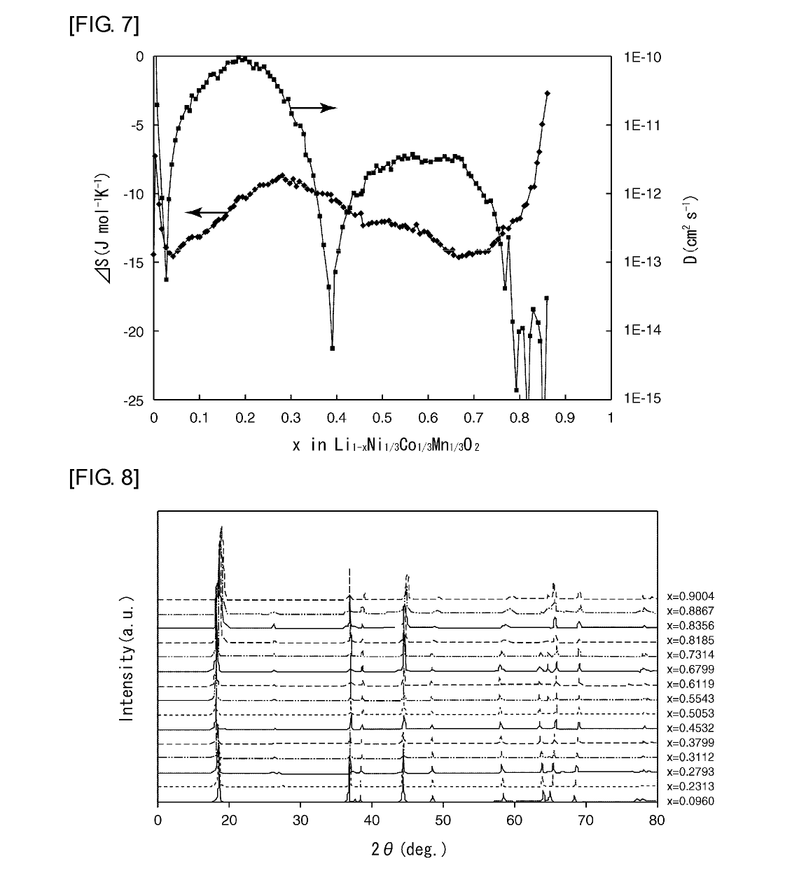

FIG. 7 shows graphs representing entropy variation and chemical diffusion coefficient against amount of lithium in the positive-electrode active material in this example.

Referring to the results shown in FIG. 7, the entropy variation increased with increasing amount of lithium eliminated until the amount of lithium eliminated reached approximately 0.3. When the amount of lithium eliminated exceeded approximately 0.3, the entropy variation decreased with increasing amount of lithium eliminated. When the amount of lithium eliminated reached and exceeded approximately 0.7, the entropy variation increased again with increasing amount of lithium eliminated. It can be seen from these results that LiNi_{1/3}Co_{1/3}Mn_{1/3}O₂ changes the entropy variation less than does lithium cobaltate, and it causes no phase transition.

Furthermore, referring to the X-ray diffraction patterns shown in FIG. 8, it can be seen that each set of corresponding diffraction peaks of all of the diffraction profiles can be identified by the same plane indices, and the structure of the positive-electrode active material therefore did not change and remained the O3 structure. On the other hand, referring again to FIG. 7, the chemical diffusion coefficient reached local maximum values when the amount of lithium eliminated was approximately 0.2 and approximately 0.6. This shows that with changes in state of charge, the positive-electrode active material caused a slight structural change without involving any phase transition. It can be assumed that this slight structural change indicates that the oxidation numbers of Ni and Co in LiNi_{1/3}Co_{1/3}Mn_{1/3}O₂ may have changed. These changes in the oxidation numbers of Ni and Co in LiNi_{1/3}Co_{1/3}Mn_{1/3}O₂ could not be detected even by the X-ray diffraction patterns shown in FIG. 8. According to the evaluation method of this invention, such a structural change of a positive-electrode active material, which could not be seen from X-ray powder diffraction measurement, could be evaluated.

### Comparative Example

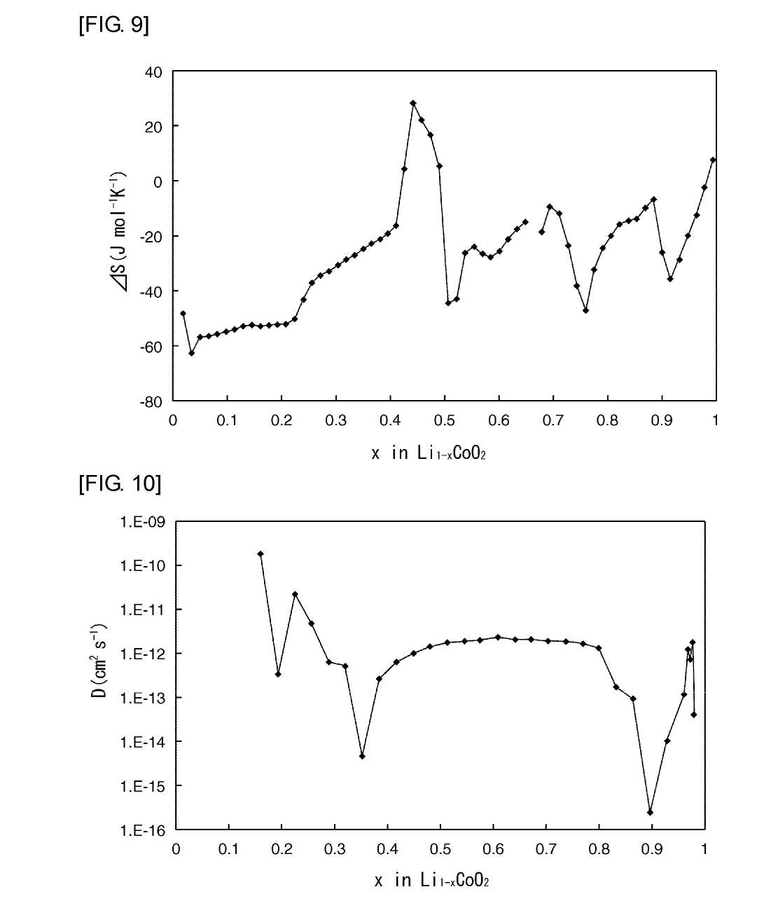

This comparative example relates to the case where chemical diffusion coefficients of a test cell in different states of charge are determined after the completion of determination of entropy variations thereof in different states of charge. Specifically, the evaluation was performed in the following manner. First, a test cell was produced in the same manner as in Example 1. Then, entropy variations of the test cell in different states of charge were determined. More specifically, the open circuit voltage of the test cell was measured for 10 minutes at each temperature of 25° C., 15° C., 5° C. and −5° C. Next, the average value of voltages at each temperature was defined as the open circuit voltage (OCV) at that temperature. Next, the OCVs at the different temperatures were plotted on a graph by laying off temperatures as abscissas and OCVs as ordinates, and an approximate curve of OCV vs. temperature was determined. Then, an entropy variation was calculated from the approximate curve. Thereafter, entropy variations of the test cell in different states of charge were determined by changing the state of charge of the test cell while keeping the temperature at 25° C. The results are shown in FIG. 9.

Next, the test cell was discharged at 25° C. until the potential of the working electrode reached 2 V with respect to the reference electrode. Then, the potential change of the test cell was measured at 25° C. while the current was passed through the test cell with a current density of 1/10 It for 10 minutes. The measured results were plotted on a graph by laying off one-half powers (t^{1/2}) of the time t as abscissas and potentials as ordinates, and an approximate curve of potential vs. time and its gradient were determined. Next, after the completion of the passage of current, the test cell was allowed to stand for 180 minutes. Thereafter, the potential of the working electrode was measured with respect to the reference electrode, and the measured potential was defined as an equilibrium potential. Then, based on the obtained results, a chemical diffusion coefficient was calculated in the same manner as in Example 1. These measurements were made in different states of charge, and chemical diffusion coefficients in the different states of charge were determined. The results are shown in FIG. 10.

Comparison between FIGS. 9 and 5 has shown that as for entropy variations, Comparative Example provided similar results to those in Example 1. On the other hand, it can be seen from comparison between FIGS. 10 and 5 that Comparative Example could not determine similar chemical diffusion coefficients to those obtained in Example 1. Firstly, in Comparative Example, only data at amounts of lithium eliminated of approximately 0.15 and more could be determined. It can be assumed that the reason for this is that at the start of determination of chemical diffusion coefficients, lithium eliminated by the determination of entropy variations was not yet sufficiently inserted again. Therefore, in Comparative Example, completely different results of determined chemical diffusion coefficients from those in Example 1 were obtained until the amount of lithium eliminated reached near 0.4. Secondly, in Comparative Example, there appeared no change in chemical diffusion coefficient due to such a structural change as detected in Example 1. Thirdly, in the graph of FIG. 10, such a plateau region of chemical diffusion coefficients as detected in Example 1, which can be assumed to show the O1 structure, did not also appear. It can be assumed that the reason for this is that the chemical diffusion coefficient changed because the amount of lithium enough to cause a phase transition to the O1 structure was not eliminated and the phase transition to the O01 structure did not occur.

It can be seen from the above that if chemical diffusion coefficients are determined after the determination of entropy variations, the nature of the positive-electrode active material is significantly changed during determination of entropy variations, so that chemical diffusion coefficients cannot be strictly and accurately determined. It can be seen that, by contrast, in Example 1 in which entropy variations and chemical diffusion coefficients for a single test cell were determined in a single procedure, the entropy variations and chemical diffusion coefficients can be strictly and correctly determined.

What is claimed is:

1. A method for evaluating a secondary battery, comprising repeatedly performing:
an open circuit voltage measurement step of measuring the open circuit voltage of a secondary battery to be evaluated at each of a plurality of temperatures;
a potential change measurement step of measuring, after the open circuit voltage measurement step, the potential change in the secondary battery while changing the state of charge of the secondary battery; and
an equilibrium potential measurement step of measuring the equilibrium potential of the secondary battery after the potential change measurement step, wherein
an entropy variation in each of the different states of charge is calculated based on the open circuit voltages at the plurality of temperatures measured in the state of charge,
a chemical diffusion coefficient in each of the different states of charge is calculated based on the equilibrium potential of the secondary battery and the potential change in the secondary battery both measured in the state of charge, and
the secondary battery is evaluated based on the entropy variations and the chemical diffusion coefficients in the different states of charge.

2. The method for evaluating a secondary battery according to claim 1, wherein the open circuit voltage measurement step is performed while the state of charge after the completion of the equilibrium potential measurement step is kept.

3. The method for evaluating a secondary battery according to claim 1, wherein the entropy variation is calculated by multiplying the ratio (δ(ΔE)/δT) of the variation (ΔE) in open circuit voltage to the variation (δT) in temperature by the Faraday constant (F), the ratio (δ(ΔE)/δT) being determined from results of the measured open circuit voltages at the plurality of temperatures.

4. The method for evaluating a secondary battery according to claim 1, wherein if the inequality t<<L²/D is satisfied where t is the charging time in the potential change measurement step, L is the thickness (cm) of an electrode in the secondary battery and D is a chemical diffusion coefficient, the chemical diffusion coefficient (D) is calculated according to the following formula (I):
D=(4/π)(V_{M}/SFzᵢ)²[{I₀(dE/dδ)}/(dEₜ/dt^{1/2})]² (1)
where:
D represents the chemical diffusion coefficient;
V_{M} represents the volume per mole of an active material (unit: cm³/mol);
S represents the area of the interface between the electrode and an electrolyte (unit: cm²);
F represents the Faraday constant;
zᵢ represents the electrical conductivity due to the charge number;
I₀ represents the applied current (unit: A);
E represents the open circuit voltage (unit: V);
dδ represents the deviation of chemical species contributing to the electrochemical reaction (unit: moles);
Eₜ represents the potential during charging or discharging; and
t represents the charging time (unit: seconds).

5. The method for evaluating a secondary battery according to claim 1, wherein the secondary battery to be evaluated is a lithium secondary battery.
